(19) United States
(12) Patent Application Publication
(10) Pub. No.: US 2007/0071447 A1
(43) Pub. Date: Mar. 29, 2007

(54) Optical receiving apparatus and dispersion compensating method therein

(75) Inventors: Masakazu Ozaki, Kawasaki (JP); Katsumi Fukumitsu, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/313,966

(22) Filed: Dec. 22, 2005

(30) Foreign Application Priority Data
Sep. 27, 2005 (JP) 2005-280400

(51) Int. Cl. H04B 10/12

(52) U.S. Cl. 398/147

(57) ABSTRACT

An optical receiving apparatus has a route change detector for detecting occurrence of a route change of received signal light, a memory for beforehand storing optimum dispersion compensation quantity for the received signal light before and after the route change, a tunable dispersion compensator for compensating dispersion of the received signal light, and a controller for controlling a dispersion compensation quantity used by the tunable dispersion compensator according to the optimum dispersion compensation quantity for the received signal light after the route change, which is beforehand stored in the memory, when the route change detector detects occurrence of the route change. The dispersion compensation quantity can be optimized at high-speed for each of optical transmission routes of the received signal light.

### CROSS REFERENCE TO RELATED APPLICATIONS

This application is based on and hereby claims priority to Japanese Application No. 2005-280400 filed on Sep. 27, 2005 in Japan, the contents of which are hereby incorporated by reference.

### BACKGROUND OF THE INVENTION

(1) Field of the Invention

The present invention relates to an optical receiving apparatus and a dispersion compensating method in the optical receiving apparatus. Particularly, the present invention relates to a technique suitable for dispersion compensation in a receiving terminal in large-capacity optical transmission at 40 Gbps, for example.

(2) Description of Related Art

A patent document 1 below has proposed a technique in relation with an optical receiver which can perform dispersion compensation in an optical communication system in which the routing of an optical transmission line is changed. The optical receiver disclosed in the patent document 1 estimates a total dispersion quantity from an electric signal obtained by photo-electrically converting received signal light, determines an identification threshold value and an identification timing of the received data on the basis of the total dispersion quantity, performs equivalently dispersion compensation of the optical wavelength without using routing information of the optical transmission line, thereby coping with a change in the routing of the optical transmission line.

[Patent Document 1] Japanese Patent Application Laid-Open Publication No. 2004-15552

In large-capacity wavelength division multiplex (WDM) transmission at 40 Gbps or the like, the dispersion allowable quantity at the receiving terminal is very severe (approximately ±30 ps) as compared with the dispersion allowable quantity (approximately ±1600 ps) in the existing 10 Gbps transmission. For this, in the large-capacity transmission at 40 Gbps or the like, it is important how the dispersion quantity of the received signal light is compensated and the signal is optimally received at the signal receiving terminal. Namely, it is necessary to optimize the dispersion compensation quantity.

In a system where the transmission route of the received signal light is not changed, it is sufficient that the optimum dispersion compensation quantity is fixed at the signal receiving terminal. However, there are ring networks such as optical UPSRs (Unidirectional Path Switched Rings), point-to-point networks where a line in the working system and a line in the protection system are set, etc. In which, the distance of a line in which the signal light is transmitted is not always constant, thus the dispersion quantity in the line is varied.

When line abnormality occurs in the working system, for example, it is general that a process of switching the line to the protection system or the like is performed to maintain the communication. However, in the case of large-capacity optical transmission at 40 Gbps or the like, if the dispersion is compensated at the receiving end and the dispersion compensation quantity is optimized according to the state of each of the lines (of the working system and the protection system), disconnection of the communication in the network might occur in the worst case.

Even if the technique disclosed in the above patent document 1, which estimates the total dispersion quantity from an electric signal obtained by photo-electrically converting received signal light and determines the identification threshold value and the identification timing of the received data without detecting a line switching, is applied to such event, a time might be required until the dispersion compensation quantity is stabilized at the optimum dispersion compensation quantity after the routing is changed (sweep operation), which causes occurrence of a long-time communication disconnection state.

### SUMMARY OF THE INVENTION

In the light of the above problems, an object of the present invention is to optimize the dispersion compensation quantity at high speed for each of optical transmission routes of received signal light by detecting a change in the optical transmission route of the received signal light and controlling the dispersion compensation quantity used by the dispersion compensator, with the detection as a trigger.

To achieve the above object, one aspect of the present invention provides an optical receiving apparatus and a dispersion compensating method in the optical receiving apparatus below:

(1) The optical receiving apparatus comprising a route change detecting means for detecting occurrence of a route change of a received signal light, a memory for beforehand storing optimum dispersion compensation quantities for the received signal light before and after the route change, a tunable dispersion compensator for compensating dispersion of the received signal light, and a controlling means for controlling a dispersion compensation quantity used by the tunable dispersion compensator according to the optimum dispersion compensation quantity for the received signal light after the route change, which is beforehand stored in the memory.

(2) The route change detecting means may comprise a route information detecting unit for receiving the received signal light from an optical frame in which route information is mapped, and detecting the route information from the optical frame, and a route information monitoring unit for monitoring a change in the route information detected by the route information extracting detecting to detect occurrence of the route change.

(3) The route change detecting means may comprise a received optical power monitoring unit for monitoring received signal light powers before and after the route change, and detecting transition of one of the received signal light powers to a disconnection state to detect occurrence of the route change.

(4) The tunable dispersion compensator may be comprised of a virtually imaged phased array (VIPA) element.

(5) The dispersion compensating method in the optical receiving apparatus having a tunable dispersion compensator compensating dispersion of a received signal light comprising the steps of storing beforehand optimum dispersion compensation quantities before and after a route change of the received signal light, monitoring occurrence of the route change of the received signal light, and controlling a dispersion compensation quantity used in the tunable dispersion compensator according to the optimum dispersion compensation quantity for the received signal light after the route change, which is stored in the memory, when occurrence of the route change is detected.

According to the present invention, when a route change (switch) of the received signal light is detected, the dispersion compensation quantity used by the tunable dispersion compensator is adjusted (optimized) according to the optimum dispersion compensation quantity for the received signal light after the route change, which is beforehand stored in the memory. Therefore, it is possible to realize excellent signal light receiving without causing occurrence of a communication disconnection even when a route change occurs.

### BRIEF DESCRIPTION OF THE DRAWINGS

FIG. 1 is a block diagram showing an example of optical transmission systems (OPUSR network) according to an embodiment of this invention;

FIG. 2 is a block diagram showing another example of optical transmission systems (point-to-point network) according to the first embodiment of this invention;

FIG. 3 is a block diagram showing a structure of a receiving side LTE in FIGS. 1 and 2;

FIG. 4 is a block diagram showing a structure of a dispersion compensator in FIG. 3;

FIG. 5 is a diagram showing a frame format of an OTN frame according to embodiments of this invention;

FIG. 6 is a flowchart for illustrating an operation of the receiving side LTE according to the embodiments of this invention;

FIG. 7 is a block diagram showing a structure of a receiving side LTE according to a second embodiment of this invention;

FIG. 8 is a block diagram showing a structure of a receiving side LTE according to a third embodiment of this invention;

FIG. 9 is a block diagram showing a structure of an LTE on the receiving side according to a fourth embodiment of this invention; and

FIG. 10 is a block diagram showing a structure of an optical transmission system according to the fourth embodiment of this invention.

### DESCRIPTION OF THE PREFERRED EMBODIMENTS

[1] Description of First Embodiment

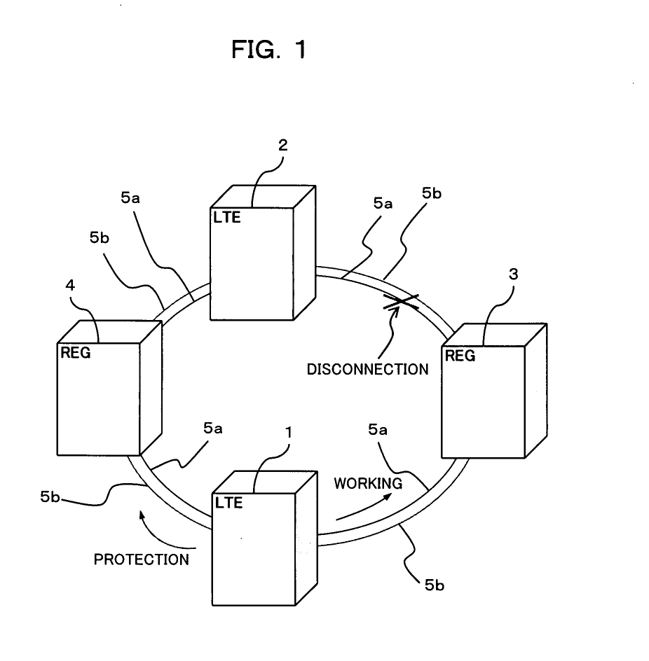

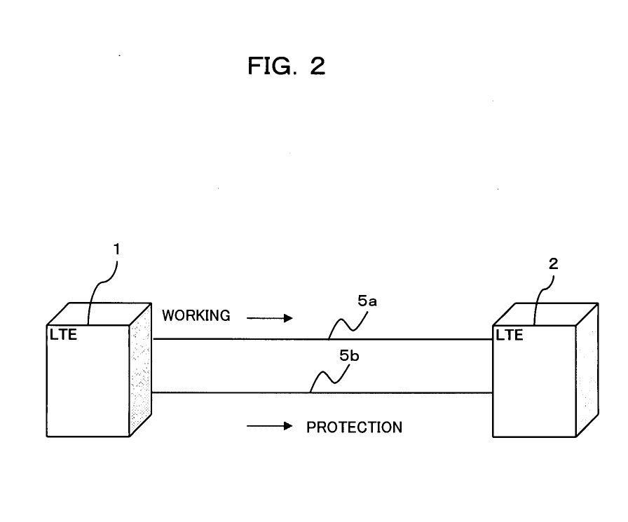

FIGS. 1 and 2 are block diagrams showing examples of an optical transmission system (network) according to a first embodiment of this invention. FIG. 1 shows a structure of an OUPSR network, while FIG. 2 shows a structure of a point-to-point network. The OUPSR network shown in FIG. 1 is configured by connecting, for example, two terminal node apparatuses (LTE: Lite Terminating Equipment) 1 and 2, and two regenerating apparatuses (Regenerators) 3 and 4 are connected through two optical transmission lines (optical fibers) 5a and 5b to form a ring network. In which, the same signal light is transmitted from the LTE 1, which is a transmitting end of the signal light, in both directions (namely, toward the regenerating apparatuses 3 and 4) through the different optical transmission lines 5a and 5b (of the working system and the protection system), while the LTE 2, which is a receiving end of the signal light, receives the signal light from the both directions (from the regenerating apparatuses 3 and 4) through the different optical transmission lines 5a and 5b, selects signal light that has better signal quality, and receives it. When one (the working system) of the two optical transmission lines 5a and 5b is disconnected, for example, only the signal light through the optical transmission line 5b in the protection system from the other direction where the disconnection does not occur is inevitably received by the LTE 2.

In the point-to-point network shown in FIG. 2, a terminal node apparatus (LTE) 1, which is a transmitting end of signal light, and a terminal node apparatus (LTE) 2, which is a receiving end of the signal light, are opposed to each other and connected through two (working system and protection system) optical transmission lines 5a and 5b. When the optical transmission line 5a in the working system is disconnected, for example, the LTE 1 transmits the signal light to the LTE 2 through the optical transmission line 5b in the protection system.

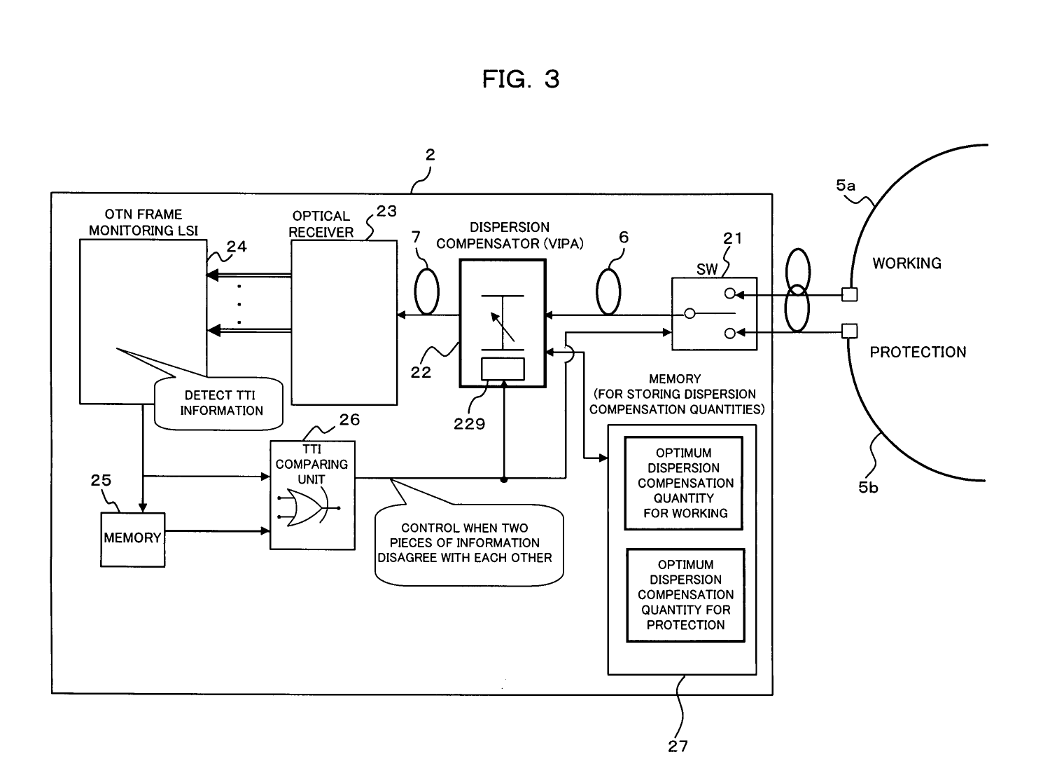

The LTE 2 (hereinafter referred to as “the receiving side LTE 2” or simply “the receiving end 2”), which is a receiving end according to this embodiment, optimizes the dispersion compensation quantity for the received signal light when a line switching occurs (a change in the optical transmission route of the received signal light) as. described above to avoid long-time communication disconnection. As shown in FIG. 3, for example, the receiving terminal 2 according to this embodiment comprises an optical switch 21, a dispersion compensator (tunable dispersion compensator) 22, an optical receiver 23, an OTN frame monitoring LSI 24, a memory 25, a TTI (Trail Trace Identifier) comparing unit 26, and a memory for storing dispersion compensation quantities 27. The optical switch 21 and the dispersion compensator 22 are connected through an optical fiber 6, while the dispersion compensator and the optical receiver 23 is connected through an optical fiber 7.

The optical switch 21 selectively outputs signal light transmitted through the optical transmission line 5a in the working system or the signal light transmitted through the optical transmission line 5b in the protection system to the optical fiber 6 (dispersion compensator 22), where the selection and outputting of the signal light in the working system or the protection system are controlled according to a switching signal from the TTI comparing unit 26.

The dispersion compensator 22 compensates dispersion of the signal light inputted through the optical fiber 6. In this embodiment, the dispersion compensator 22 is triggered by the control signal supplied from the TTI comparing unit 26 when a line switching occurs, reads out an optimum dispersion compensation quantity of the working system or the protection system beforehand stored in the memory 27, and performs dispersion compensation on the above signal light on the basis of this dispersion compensation quantity.

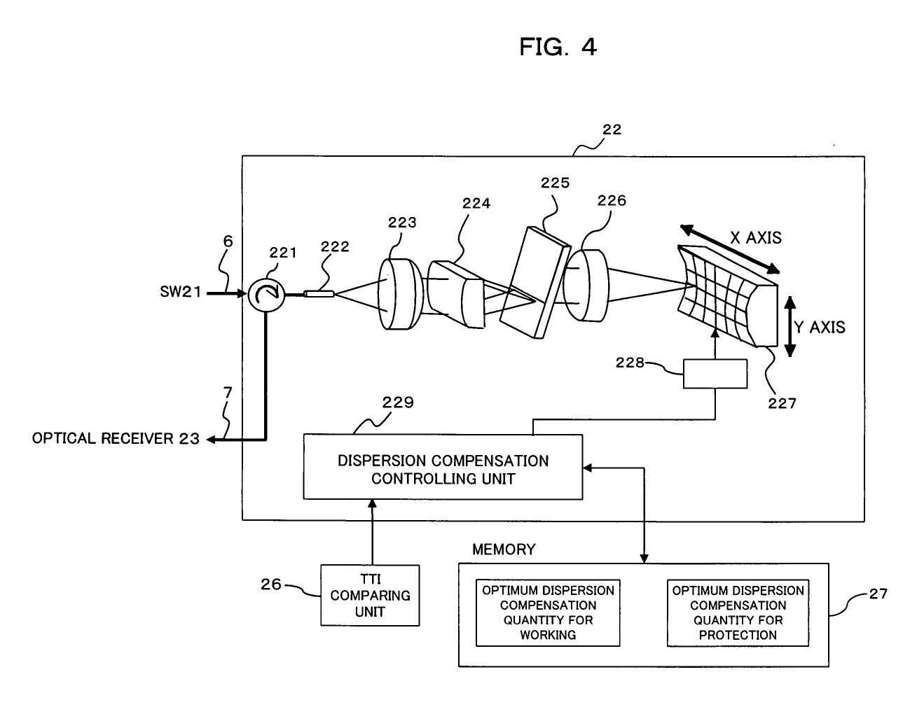

For this purpose, the dispersion compensator 22 of this embodiment comprises, as shown in FIG. 4, for example, an optical circulator 221, a collimator lens 223, a line focusing lens (cylindrical lens) 224, an optical element 225, a focusing lens 226, a three-dimensional free surface mirror 227, an actuator 228 and a controller (dispersion compensation controlling unit) 229.

The optical circulator 221 outputs light inputted from the optical fiber 6 (optical switch 21) to the collimator lens 223, while outputting light from the collimator lens 223 to the optical fiber 7 (optical receiver 23). Namely, the light outputted from the optical switch 21 to the optical circulator 221 travels through the collimator lens 223, the line focusing lens 224, the optical element 225 and the focusing lens 226, and is reflected by the three-dimensional free surface mirror (hereinafter simply referred to as a mirror, occasionally) 227. The reflected fed-back light inputted to the optical circulator 221 along the reverse route is outputted to the optical receiver 23 through the optical fiber 7.

In relation to the light outputted from the optical circulator 221 and reflected by the three-dimensional free surface mirror 227, the collimator lens 223 causes (collimates) the light from the optical circulator 221 to be parallel light. The line focusing lens 224 causes the parallel light from the collimating lens 223 to be a line-focused light (light whose focal point is distributed like a line), and outputs the light to the optical element 225.

The optical element 225 is composed of parallel plates, which reflect in multiple the light outputted from the line focusing lens 223 inside the parallel plates to cause the light to self-interfere, thereby outputting the light at different output angles correspondingly to respective wavelengths to form virtual images arranged in tiers, that is, virtually imaged phased array. The optical element 225 is generally referred to as a VIPA element. The operation and principle of the VIPA element 225 are known, detailed description of which are thus omitted here.

The focusing lens 226 converges the line-like signal light emitted from the VIPA element 225 into a point on the surface of the mirror 227 in the following stage. Namely, the focusing lens 226 converges the line-like (band-like) light parallel to the X axis of the mirror 227 in FIG. 4 into a point positioned in the vicinity of the lower part, on the paper, of the mirror 227 when the light has a long wavelength, in the vicinity of the center of the mirror 227 when the light has a middle wavelength, or in the vicinity of the upper part, on the paper, of the mirror 227 when the light has a short wavelength.

The mirror 227 reflects the light from the focusing lens 226, and outputs the reflected fed-back light to the focusing lens 226. Concretely, the mirror 227 reflects the light converged by the focusing lens 226 and feeds back the light to the same lens 226 so that the fed-back signal light (reflected fed-back light) is undergone multiple reflection inside the VIPA element 225 and outputted as signal light to the optical receiver 23. The mirror 227 can give different wavelength dispersion to the light to be outputted to the optical receiver 23 according to the position on the reflecting surface of the signal light converged by the lens 226.

The reflecting surface of the mirror 227 is a three-dimensional curved surface that can arbitrarily adjust the angle of reflection of the reflected fed-back light by that the incident position of the light from the focusing lens 226 is changed (moved) by driving the mirror 227 by the actuator 228.

Namely, the angle of reflection of the reflected fed-back light of the light from the focusing lens 226 can be adjusted by driving the mirror 227, whereby the incident position on the reflecting film on the VIPA element 225 of the reflected fed-back light can be set. In other words, it is possible to set a difference in optical path length due to the multiple reflection of the reflected fed-back light inside the parallel plates forming the VIPA element 225 according to the incident position on the reflecting film of the VIPA element 225 of the reflected fed-back light.

The reflected fed-back light in which each wavelength is given a difference in optical path length by the VIPA element 225 is outputted to a fiber end 222 through the line focusing lens 224 and the collimator lens 223, inputted again to the optical circulator 221 and outputted to the optical fiber 7 (optical receiver 23). Accordingly, the optical system comprised of the collimator lens 223, the line focusing lens 224, the VIPA element 225, the focusing lens 226 and the mirror 227 can provide a dispersion characteristic equivalent to a dispersion characteristic that a transmission line actually connected has.

The dispersion compensator 22 with the VIPA element 225 can realize about 200 ps as its dispersion compensation quantity tunable width.

The dispersion compensation controlling unit (controlling means) 229 is triggered by the control signal inputted from the TTI comparing unit 26 to read out an optimum dispersion compensation quantity of the working system or the protection system beforehand stored in the memory 27, drives (controls) the actuator 228 according to this compensation quantity to control the position of the mirror 227 as above, thereby adjusting the dispersion quantity. For example, when the control signal from the TTI comparing unit 26 indicates a line switching from the optical transmission line 5a of the working system to the optical transmission of the protection system, the position of the mirror 227 is controlled according to the optimum dispersion compensation quantity for the protection system. On the other hand, when the control signal indicates a line switching from the optical transmission line 5b of the protection system to the optical transmission line 5a of the working system, the position of the mirror 227 is controlled according to the optimum dispersion compensation quantity for the working system.

In FIG. 3, the optical receiver 23 receives light outputted from the dispersion compensator 22 (optical fiber 7) by an optical receiving element such as a photo diode (PD) or the like, and outputs an electric signal according to a quantity of the received light. The OTN (Optical Transport Network) frame monitoring LSI (route information extracting unit) 24 has a function of monitoring an OTN frame (optical frame) inputted as an electric signal from the optical receiver 23 and extracting TTI information (64 bytes) which is route information of the signal light included in the overhead of the OTN frame.

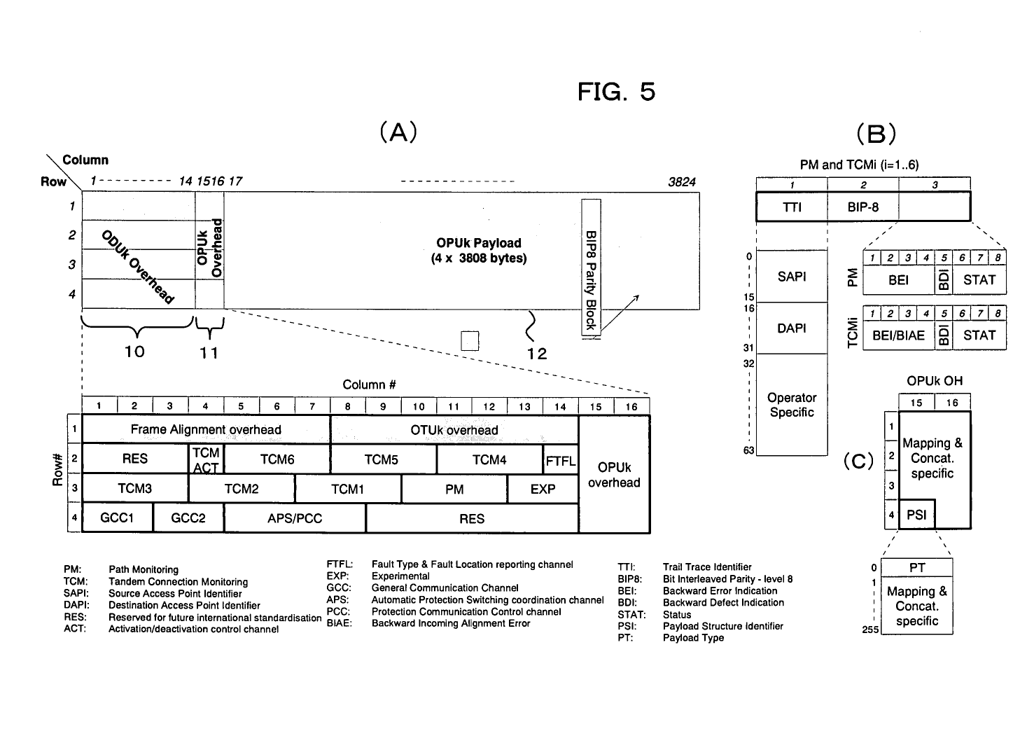

In concrete, the OTN frame has, as shown in (A) in FIG. 5, for example, an optical channel data unit (ODUk) overhead 10 of 4 rows (Row) by 14 columns (Column) (bytes), an optical channel payload unit (OPUk) overhead 11 of 4 rows by 2 columns following the ODUk overhead 10, and an OPUk payload 12 of 4 rows by 3808 columns following the OPUk overhead 11. Supervisory control signals for various kinds of maintenance and operations are mapped in the overheads 10 and 11, various user data (client signals) are mapped in the OPUk payload 12, and they are transmitted.

The TTI information is mapped at the first byte in the PM (Path Monitoring) field positioned at the third row and tenth to twelfth columns of the ODUk overhead 10, as shown in (A) and (B) in FIG. 5. Accordingly, the OTN frame monitoring LSI 24 extracts the TTI information (bytes) from the PM field. As shown in (B) in FIG. 5, the TTI information includes Source Access Point Identifier (SAPI), Destination Access Point Identifier (DAPI), and Operator Specific. By monitoring a change in contents of the SAPI and DAPI, a route change of the signal light can be detected. However, since the SAPI, DAPI and Operator Specific are information (64 bytes in total) that becomes complete at a point of that that 64 OTN frames have been received, the OTN frame monitoring LSI 24 has to wait a period of time (about 16 nano seconds) until at least the 64 OTN frames have been received, in order to extract the TTI information.

As shown in (B) in FIG. 5, various information of BEI (Backward Error Indication), BDI (Backward Defect Indication) and STAT (Status) is mapped at the third byte of the PM field. Various information of BEI/BIAE (Backward Incoming Alignment Error), EDI and STAT is mapped at the third byte of a TCM (Tandem Connection Monitoring) i (i =1 to 6) field, as well. (C) in FIG. 5 shows information mapped in the OPUk overhead 11.

As shown in (B) in FIG. 5, the TTI information may be mapped in any one of six TCMi fields. The fields of TCM1, TCM2 and TCM3 are fields (information field terminated at the regenerating apparatus) prepared for a section called a regenerator section in SONET, while the fields of TCM4, TCM5 and TCM6 are fields (information field terminated at the terminating apparatus) prepared for a section called a line section in SONET.

When the receiving terminal 2 monitors the TTI information as does in this embodiment, the monitoring LSI 24 may monitor (extract) the TTI information mapped in any one of the TCM4, TCM5 and TCM6 fields instead of the PM field.

In FIG. 3, the memory 25 beforehand stores the TTI information in the normal state extracted by the OTN frame monitoring LSI (hereinafter referred to simply as “monitoring LSI”) 24 when the network is started up. The memory 25 may be comprised of a required storage device such as an EEPROM (Electrically Erasable Programmable Read-Only Memory) or the like.

The TTI comparing unit 26 compares the TTI information held in the memory 25 with TTI information extracted by the monitoring LSI 24. When the both pieces of information do not coincide with each other (when a difference occurs), the TTI comparing unit 26 recognizes that a line switching from the working system to the protection system (or vice versa) (a route change of the received signal light) occurs, and notifies the dispersion compensator 22 (dispersion controlling unit 229) and the optical switch 21 of it, using a control signal.

The memory 25 and the TTI comparing unit 26 together function as a route information monitoring unit which detects occurrence of a line switching (a route change) by monitoring a change in the TTI information extracted by the monitoring LSI 24. Besides, the memory 25, the TTI comparing unit 26 and the monitoring LSI 24 together function as a route change detecting means which detects occurrence of a route change of the received signal light.

The memory 27 beforehand stores an optimum dispersion compensation quantity for the received signal light from the optical transmission line 5a of the working system and an optimum dispersion compensation quantity for the received signal light from the optical transmission line 5b of the protection system when the system is started up, for example. Like the memory 25, the memory 27 may be comprised of a required storage device such as an EEPROM or the like.

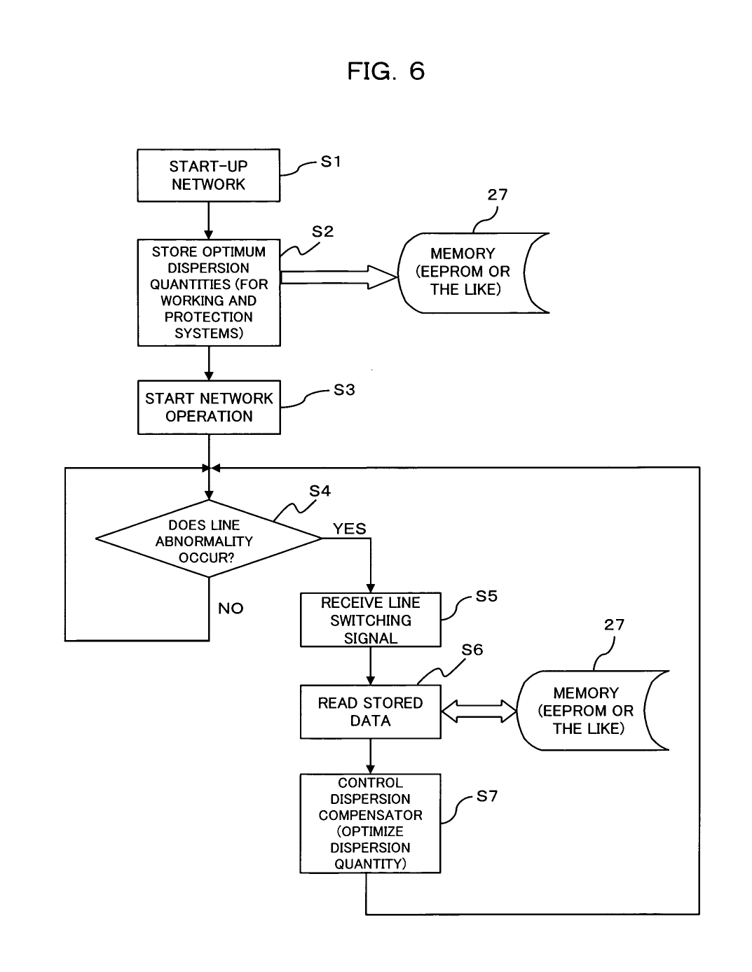

Next, description will be made of an operation at the receiving end 2 structured as above according to this embodiment with reference to a flowchart shown in FIG. 6.

When the network is started up (step S1), the optimum dispersion compensation quantities for the optical transmission line 5a of the working system and the optical transmission line 5b of the protection system are stored in the memory 27 (step S2). When the operation of the network is started thereafter (step S3), the receiving end 2 starts a line monitoring process. Namely, in the receiving end 2, signal light from the optical transmission line 5a of the working system is selected as the received signal light by the optical switch 21 and inputted to the dispersion compensator 22, and dispersion compensation of the received signal light is performed according to the optimum dispersion compensation quantity for the working system stored in the memory 27. The received signal light undergone the dispersion compensation by the dispersion compensator 22 is converted into an electric signal by the optical receiver 23, and inputted to the monitoring LSI 24. The TTI information is extracted from the ODUk overhead 10 of the OTN frame of the signal by the monitoring LSI 24 as described above, and inputted to the TTI comparing unit 26.

The TTI comparing unit 26 compares the TTI information fed from the monitoring LSI 24 with the TTI information beforehand stored in the memory 25, and checks whether the two pieces of information coincide with each other or not (whether line abnormality occurs or not) (step S4). When the two pieces of information do not coincide as a result, the TTI comparing unit 26 recognizes that line abnormality occurs, and outputs a line switching signal (from the working system to the protection system) as the control signal to the optical switch 21 and the dispersion compensator 22 (from YES route at step S4 to step S5).

Whereby, the input of the optical switch 21 is switched to the optical transmission line 5b of the protection system. Thereafter, the signal light from the optical transmission line 5b of the protection system is selected as the received signal light, and inputted to the dispersion compensator 22. At this time, the above line switching signal is inputted to the dispersion compensation controlling unit 229 in the dispersion compensator 22. Responsive to it, the dispersion compensation controlling unit 229 accesses to the memory 27, reads out the optimum dispersion compensation quantity for the protection system (step S6), drives the actuator 228 according to the optimum dispersion compensation quantity for the protection system to control the position of the mirror 227, thereby performing optimization of the dispersion quantity of the received signal light in the protection system (step S7).

After that, the receiving end 2 repeats the process at and after the step S4 to monitor a change in the TTI information, thereby detecting whether a line switching occurs or not. Each time a line switching occurs, the receiving end 2 performs switching of the optical switch 21 and optimization of the dispersion quantity for either the working system or the protection system. Incidentally, there is a mode where, when the fault of the working system is restored, the operation using the protection system is continued (a line switching back to the restored working system is not performed).

According to this embodiment, a route change of the received signal light (line switching) is detected by monitoring (detecting) a change in the TTI information mapped in the ODUk overhead 10 of the OTN frame. With this as a trigger, the dispersion compensation quantity used by the dispersion compensator 22 is adjusted (optimized) according to the dispersion compensation quantity most suitable for a route after the line is switched beforehand stored in the memory 27. Accordingly, it is possible to realize excellent signal light receiving without a communication disconnection even when a line switching occurs. Particularly, with respect to received signal light in a large-capacity network at not less than 40 Gbps where the dispersion allowable quantity is not larger than about ±30 ps, it is possible to optimize the dispersion compensation quantity for each route at high speed, which can effectively prevent occurrence of a communication disconnection in the network.

In the above example, a route change (line switching) of the received signal light is detected by monitoring a change in the TTI information mapped in the ODUk overhead 10 of the OTN frame. Alternatively, it is possible to insert route information on the line into the undefined bytes (RES: Reserved for future international standardization) which are an idle field of the OTN frame, and monitor these idle bytes in the same manner as the above embodiment, thereby detecting a route change (line switching) of the received signal light. In which case, it becomes possible to detect early occurrence of a line switching (route change) because the route information can be obtained before 64 OTN frames have been received, unlike the case of the TTI information.

[2] Description of Second Embodiment

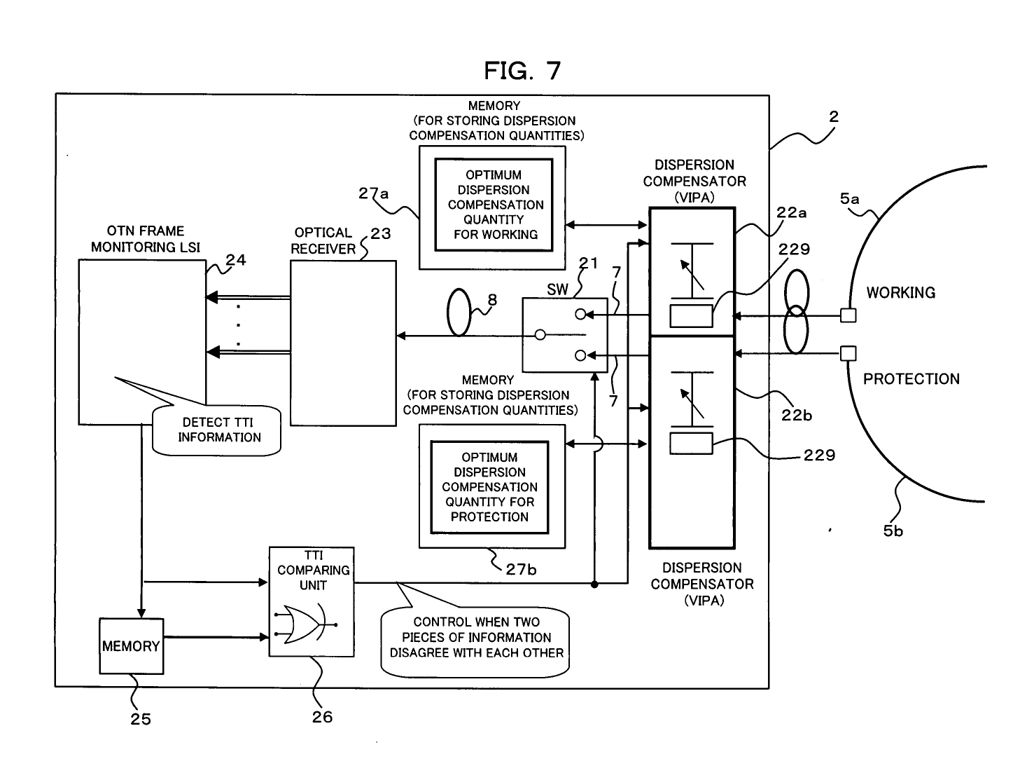

FIG. 7 is a block diagram showing a structure of a receiving side LTE according to a second embodiment of this invention. The LTE 2 shown in FIG. 7 has a structure differing from the structure shown in FIG. 3 in that two dispersion compensators (tunable dispersion compensators) 22a and 22b are connected to inputs of the optical switch 21 through optical fibers 7 correspondingly to the working system and the protection system, the input of the optical receiver 23 is connected to the output of the optical switch 21 through an optical fiber 8, and memories 27a and 27b for storing dispersion compensation quantities are provides for the working system and the protection system, respectively, as the above memory 27 for storing dispersion compensation quantities. Incidentally, other structural elements (designated by like or corresponding characters) are identical or similar ones that have been described hereinbefore unless otherwise specifically mentioned.

Each of the dispersion compensators 22a and 22b is comprised of the VIPA element 225, like the dispersion compensator 22 shown in FIGS. 3 and 4. The dispersion compensator 22a is disposed so as to perform dispersion compensation on received signal light from the optical transmission line 5a of the working system, while the dispersion compensator 22b is disposed so as to perform dispersion compensation on received signal light from the optical transmission line 5b of the protection system.

The memory 27a beforehand stores the optimum dispersion compensation quantity for the dispersion compensator 22a, that is, the received signal light from the optical transmission line 5a of the working system. The memory 27b beforehand stores the optimum dispersion compensation quantity for the dispersion compensator 22b, that is, the received signal light from the optical transmission line 5b of the protection system. Each of the memories 27a and 27b may be comprised of a required storage device such as an EEPROM or the like, for example. The memories 27a and 27b may be commonly used for the working system and the protection system, like the memory 27 shown in FIG. 3.

The receiving end 2 of this embodiment has the dispersion compensators 22a and 22b, and the memories 27a and 27b, correspondingly to the working system and the protection system, respectively.

In the receiving end 2 structured as above, the monitoring LSI 24 extracts the TTI information mapped in the ODUk overhead 10 of the OTM frame, compares this TTI information with TTI information beforehand stored in the memory 25 to monitor occurrence of a line switching (route change), as does in the first embodiment (flowchart in FIG. 6). When detecting occurrence of a line switching from the working system to the protection system, for example, because of disagreement between the two pieces of TTI information, the monitoring LSI 24 is triggered by this detection, and outputs a control signal to the optical switch 21 and the dispersion compensator 22b (dispersion compensation controlling unit 229).

The dispersion compensation controlling unit 229 in the dispersion compensator 22b accesses to the memory 27b, reads out the optimum dispersion compensation quantity for the optical transmission line 5b of the protection system, drives the actuator 228 according to the compensation quantity to control the position of the mirror 227, thereby optimizing the dispersion compensation quantity for the received signal light from the optical transmission line 5b. The optical switch 21 selects output light from the dispersion compensator 22b, and outputs it to the optical receiver 23.

When a line switching (restoration) from the protection system to the working system occurs, a control signal is given from the TTI comparing unit 26 to the dispersion compensator 22a, whereby the dispersion compensation quantity for the received signal light from the optical transmission line 5a of the working system is optimized in the similar manner.

This embodiment provides the similar effects and advantages to those provided by the first embodiment. Besides, it is possible to shorten the time required until the dispersion compensation quantity is stabilized at the optimum dispersion compensation quantity because the dispersion compensators 22a and 22b are separately provided for the working system and the protection system, respectively.

[3] Description of Third Embodiment

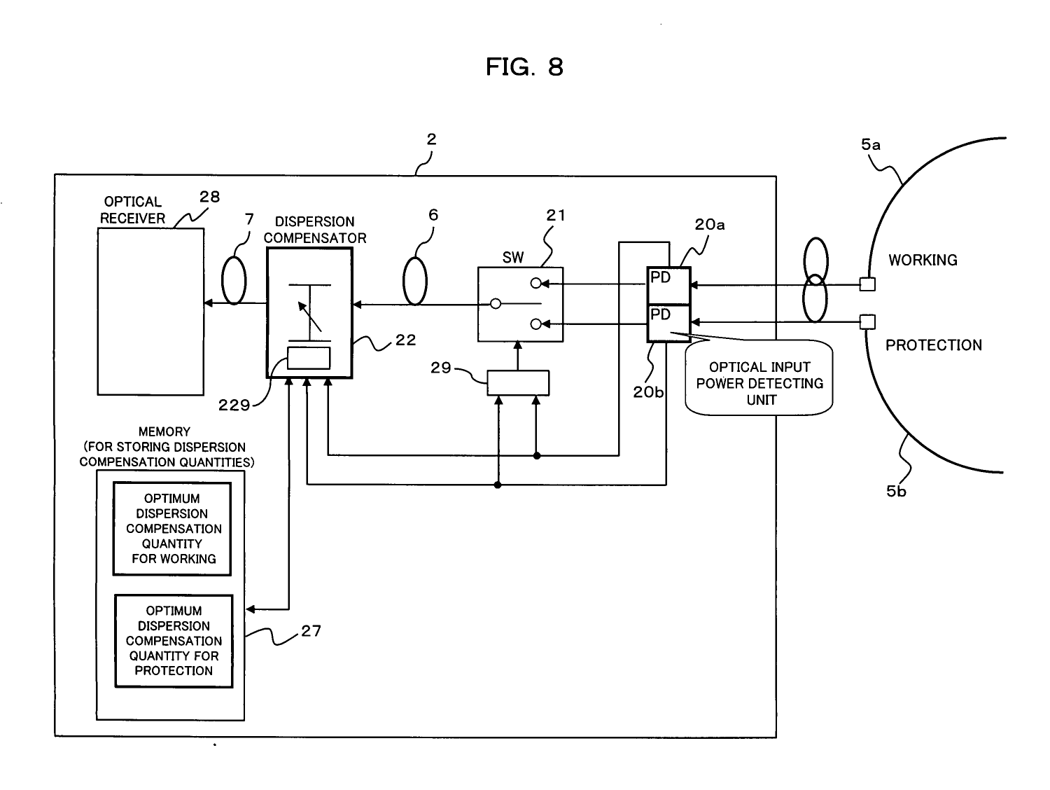

FIG. 8 is a block diagram showing a structure of a receiving side LTE according to a third embodiment of this invention. The LTE 2 shown in FIG. 8 has a structure differing from the structure shown in FIG. 8 in that photodiodes 20a and 20b as being light receiving elements are connected to two inputs of the optical switch 21, and an optical receiver 28 and an optical switch controlling unit 29 are provided in place of the monitoring LSI 24, the memory 25 and the TTI comparing unit 26. In FIG. 8, like reference characters designate like or corresponding parts described above unless otherwise specifically mentioned.

The PD 20a receives the received signal light from the optical transmission line 5a of the working system, and outputs an electric signal obtained according to the quantity of the received signal light to the dispersion compensation controlling unit 229 in the dispersion compensator 22. The PD 20b receives the received signal light from the optical transmission line 5b of the protection system, and outputs an electric signal obtained according to the quantity of the received signal light to the dispersion compensation controlling unit 229 in the dispersion compensator 22, as well.

The optical receiver 28 receives output light from the dispersion compensator 22 (optical fiber 7), and performs a required receiving process such as photoelectric conversion or the like. The optical switch controlling unit 29 monitors the electric signals from the PD 20a and D 20b to detect the optical disconnection state of the optical transmission lines 5a and 5b of the working system and the protection system, and controls the switching of the optical switch 21 according to a result of the detection. When the PD 20a does not receive the light because of occurrence of a disconnection in the optical transmission line 5a of the working system, for example, the optical switch controlling unit 29 turns the optical switch 21 to the optical transmission line 5b of the protection system (PD 20b)

Namely, the receiving end 2 of this embodiment can directly detect occurrence of a line switching (route change) by means of the PD 20a and PD 20b without relying on the optical frame of the OTN frame or the like. The PD 20a and the PD 20b together function as a received optical power monitoring unit (route change detecting means) which detects occurrence of a route change by monitoring received signal optical powers before and after the above line switching (route change) to detect transition of one of the received signal light powers to the disconnect state.

In this embodiment, the dispersion compensation controlling unit 229 in the dispersion compensator 22 reads out the optimum dispersion compensation quantity for the working system or the protection system from the memory 27 according to the states (ON/OFF state) of the electric signals inputted from the PD 20a and 20b.

When the electric signal from the PD 20a is in the OFF state while the electric signal from the PD 20b is in the ON state, the dispersion compensation controlling unit 229 recognizes that a line switching from the working system to the protection system occurs, reads out the optimum dispersion compensation quantity for the protection system from the memory 27, drives the actuator 228 according to this compensation quantity to control the position of the mirror 227, thereby optimizing the dispersion compensation quantity for the received signal light from the optical transmission line 5b of the protection system.

Conversely, when the electric signal from the PD 20a is in the ON state and the electric signal from the PD 20b is in the OFF state, the dispersion compensation controlling unit 229 recognizes that a line switching from the protection system to the working system occurs, reads out the optimum dispersion compensation quantity for the working system from the memory 27, drives the actuator 228 according to this compensation quantity to control the position of the mirror 227, thereby optimizing the dispersion compensation quantity for the received signal light from the optical transmission line 5b of the protection system.

Meanwhile, there are two modes in which, when the optical transmission line 5a (or 5b) of the working system (or the protection system) is restored and the electric signals from both the PD 20a and PD 20b become the ON state, a switching back to the restored line is performed and not. In the case where the switching back is performed, the optimum dispersion compensation quantity for the optical transmission line 5a or 5b to which the line is to be switched back is read out from the memory 27 to the dispersion compensation controlling unit 229, like the above example.

Accordingly, this embodiment provides the similar effects and advantages to those provided by the first embodiment. Besides, this embodiment can provide a simpler structure than that provided by the first embodiment, which leads to a lower cost and a shorter time for the dispersion compensation control because occurrence of a line switching (route change) can be directly detected by means of the PDs 20a and 20b without relying on the optical frame such as the OTN frame or the like.

[4] Description of Fourth Embodiment

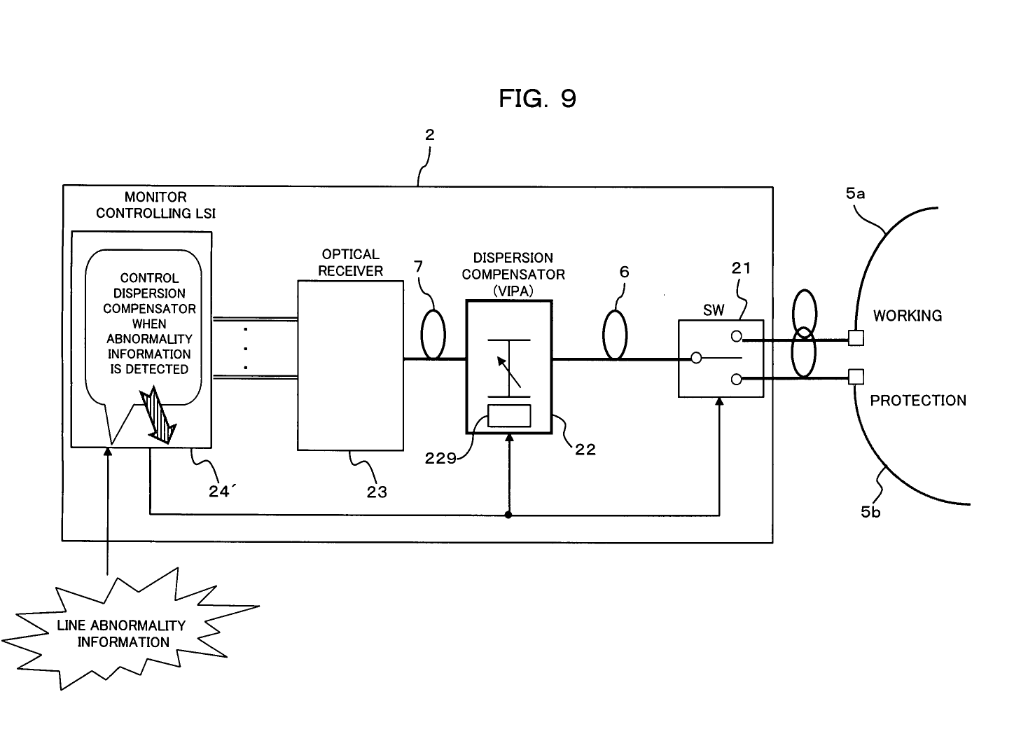

FIG. 9 is a block diagram showing a structure of a receiving side LTE according to a fourth embodiment of this invention. The LTE 2 shown in FIG. 9 has a structure differing from the structure shown in FIG. 8 in that a monitor controlling LSI 24′ is provided in place of the OTN frame monitoring LSI 24, the memory 25 and the TTI comparing unit 26. In FIG. 9, like reference characters designate like or corresponding parts described above unless otherwise specifically noted.

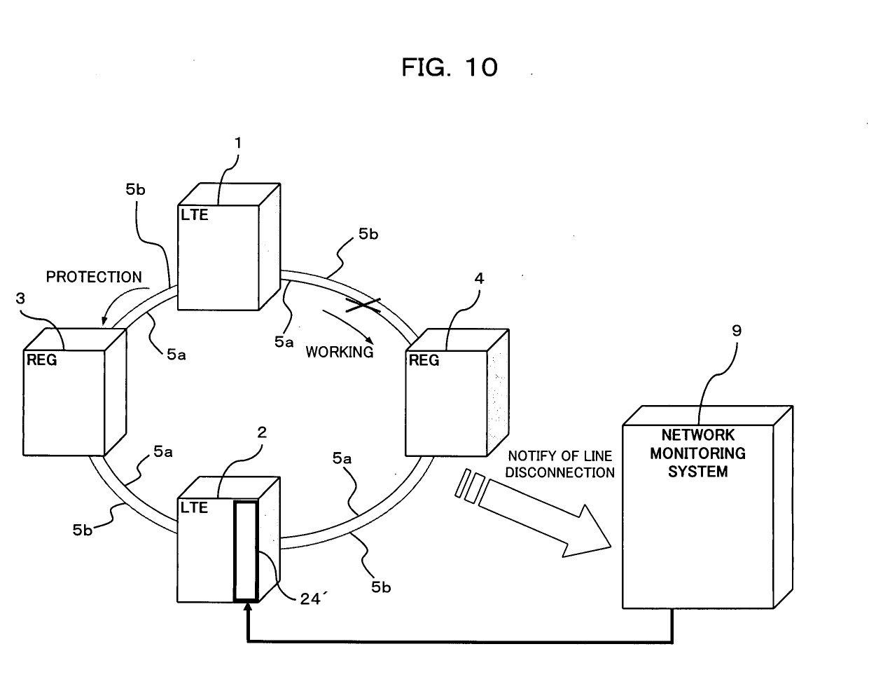

The monitor controlling LSI (line switching information detecting unit) 24′ receives line switching information from a network monitoring system 9 shown in FIG. 10, detects occurrence of a line switching (route change), and gives a control signal (line switching signal) to the optical switch 21 and the dispersion compensator 22 (dispersion compensation controlling unit 229: refer to FIG. 4) with this as a trigger. As shown in FIG. 10, for example, when the optical transmission line 5b of the working system between the LTE 1 and the regenerating apparatus 4 is disconnected, for example, and an optical disconnection thereby occurs, this optical disconnection is detected by the regenerating apparatus 4 and notified from the regenerating apparatus 4 to the network monitoring system 9. The network monitoring system 9 notified of this notifies the receiving end 2 (monitor controlling LSI 24′) of the disconnection state of the optical transmission line 5a of the working system, using line abnormality information, whereby the monitoring LSI 24′ supplies a line switching signal from the working system to the protection system as the above control signal to the optical switch 21 and the dispersion compensation controlling unit 229 in the dispersion compensator 22.

The network monitoring system 9 monitors each of the nodes (LTEs 1 and 2, and regenerating apparatuses 3 and 4) configuring the PUSR network to collect line disconnection information from each of the nodes 1, 2, 3 and 4. When a fault occurs in the optical transmission line 5a between other nodes, the network monitoring system 9 can notify the receiving end 2 (monitor controlling LSI 24′) of the line abnormality information.

Namely, the receiving terminal 2 (monitor controlling LSI 24′) of this embodiment detects occurrence of a line switching (route change) by receiving a notification of the line abnormality information from the network monitoring system 9, and optimizes the dispersion compensation quantity used in the dispersion compensator 22 for the optical transmission line 5a of the working system or the optical transmission lint 5b of the protection system, individually.

In more detail, when a fault occurs in the optical transmission line 5a of the working system and the line abnormality information is notified from the network monitoring system 9 to the receiving end 2 (monitor controlling LSI 24′), for example, the monitor controlling LSI 24′ recognizes occurrence of a line switching from the working system to the protection system, and supplies a line switching signal from the working system to the protection system as the control signal to the optical switch 21 and the dispersion compensation controlling unit 229 in the dispersion compensator 22.

Whereby, the input of the optical switch 21 is switched to the optical transmission line 5b of the protection system to select signal light from the optical transmission line 5b of the protection system as the received signal light, and the selected signal light is inputted to the dispersion compensator 22. At this time, the dispersion compensation controlling unit 229 in the dispersion compensator 22 receives the control signal from the monitor controlling LSI 24′, accesses to the memory 27 to read out the optimum dispersion compensation quantity for the protection system, drives the actuator 228 according to this compensation quantity to control the position of the mirror 227, thereby optimizing the dispersion compensation quantity for the received signal light from the optical transmission line 5b of the protection system.

When a line switching from the protection system to the working system occurs, the monitor controlling LSI 24′ in the receiving end 2 receives a notification from the network monitoring system 9, supplies the control signal to the optical switch 21 and the dispersion compensator 22 (dispersion compensation controlling unit 229), thereby optimizing the dispersion compensation quantity for the received signal light from the optical transmission line 5a of the working system in the similar manner.

There are two modes in which, when the optical transmission line 5a (or 5b) of the working system (or the protection system) is restored, a switching back to the restored line is performed and not, as well as the above embodiment. In the case of a mode where a switching back is performed, the optimum dispersion compensation quantity for the optical transmission line 5a or 5b to which the lines is switched back is read out from the memory 27 to the dispersion compensation controlling unit 229, like the above example.

According to this invention, when occurrence of a route change of the received signal light occurs, the dispersion compensation quantity used in the tunable dispersion compensator is controlled and optimized according to the optimum dispersion compensation quantity for the received signal light after the route is changed, which is beforehand stored in the memory, as described above in detail. Even when a route change occurs due to line abnormality or the like, it is possible to realize excellent signal light receiving without causing a communication disconnection, thus this invention is very useful in the field of the optical communication techniques.

[5] Others

Note that the present invention is not limited to the above examples, but may be modified in various ways without departing from the scope and sprit of the invention.

For example, a structure using the VIPA element 225 as the dispersion compensator 22 (22a and 22b) is employed in the above embodiments. However, any device may be employed as the dispersion compensator 22 so long as it has the tunable dispersion compensation function.

Application of this invention is not limited to a WDM transmission system, but this invention may be applied to any optical network so long as it has a dispersion compensator.

What is claimed is:

1. An optical receiving apparatus comprising:
a route change detecting means for detecting occurrence of a route change of a received signal light;
a memory for beforehand storing optimum dispersion compensation quantities for the received signal light before and after the route change;
a tunable dispersion compensator for compensating dispersion of the received signal light; and
a controlling means for controlling a dispersion compensation quantity used by said tunable dispersion compensator according to the optimum dispersion compensation quantity for the received signal light after the route change, which is beforehand stored in said memory.

2. The optical receiving apparatus according to claim 1, wherein said route change detecting means comprises:
a route information detecting unit for receiving the received signal light from an optical frame in which route information is mapped, and detecting the route information from the optical frame; and
a route information monitoring unit for monitoring a change in the route information detected by said route information detecting unit to detect occurrence of the route change.

3. The optical receiving apparatus according to claim 2, wherein the optical frame is an OTN (Optical Transport Network) frame, and the route information is TTI (Trail Trace Identifier) information mapped in an overhead of the OTN frame.

4. The optical receiving apparatus according to claim 2, wherein the optical frame is an OTN (Optical Transport Network) frame, and the route information is mapped in an idle field in an overhead of the OTN frame.

5. The optical receiving apparatus according to claim 1, wherein said route change detecting means comprises:
a received optical power monitoring unit for monitoring received signal light powers before and after the route change, and detecting transition of one of the received signal light powers to a disconnection state to detect occurrence of the route change.

6. The optical receiving apparatus according to claim 1, wherein said route change detecting means comprises:
a line switching information detecting unit for detecting occurrence of the route change by receiving line switching information from an optical network monitoring system which is a host system.

7. The optical receiving apparatus according to claim 1, wherein said tunable dispersion compensator is comprised of a virtually imaged phased array (VIPA) element.

8. The optical receiving apparatus according to claim 2, wherein said tunable dispersion compensator is comprised of a virtually imaged phased array (VIPA) element.

9. The optical receiving apparatus according to claim 3, wherein said tunable dispersion compensator is comprised of a virtually imaged phased array (VIPA) element.

10. The optical receiving apparatus according to claim 4, wherein said tunable dispersion compensator is comprised of a virtually imaged phased array (VIPA) element.

11. The optical receiving apparatus according to claim 5, wherein said tunable dispersion compensator is comprised of a virtually imaged phased array (VIPA) element.

12. The optical receiving apparatus according to claim 6, wherein said tunable dispersion compensator is comprised of a virtually imaged phased array (VIPA) element.

13. A dispersion compensating method in an optical receiving apparatus having a tunable dispersion compensator compensating dispersion of a received signal light comprising the steps of:
storing beforehand optimum dispersion compensation quantities before and after a route change of the received signal light;
monitoring occurrence of the route change of the received signal light; and
controlling a dispersion compensation quantity used in said tunable dispersion compensator according to the optimum dispersion compensation quantity for the received signal light after the route change, which is stored in said memory, when occurrence of the route change is detected.
